(19) United States
(12) Patent Application Publication
(10) Pub. No.: US 2006/0270478 A1
(43) Pub. Date: Nov. 30, 2006

(54) SYSTEM AND METHOD FOR MOBILE LOYALTY PROGRAM

(76) Inventors: William J. Barhydt, Los Gatos, CA (US); Michael Cartabiano, Redondo Beach, CA (US); Julian Hardy, London (GB)

Correspondence Address: ORRICK, HERRINGTON & SUTCLIFFE, LLP;IP PROSECUTION DEPARTMENT, 4 PARK PLAZA, SUITE 1600, IRVINE, CA, 92614-2558, US

(21) Appl. No.: 11/382,890

(22) Filed: May 11, 2006

Related U.S. Application Data
(60) Provisional application No. 60/679,801, filed on May 11, 2005.

(51) Int. Cl. G06F 19/00

(52) U.S. Cl. 463/41; 463/42; 705/40

(57) ABSTRACT

The present invention provides a Mobile Loyalty and Community Service (MLCS) for decreasing customer churn and increasing customer spend. In an embodiment, the MLCS provides a suite of mobile games. When a customer plays one of the mobile games, the MLCS issues points to the customer based on the customer's performance on the game (e.g., game score). Customers can redeem these points for valuable prizes from a catalog. The MLCS also provides tokens that customers can purchase and use to play pay-per-play games (e.g., one token per play). The pay-per-play games provide revenue every time a customer plays a game by requiring one or more tokens for each game play. By issuing points to customers based on their performances on the games, the MLCS motivates customers to play these games more frequency, thereby increasing customer spend. Further, the accumulation of points in their accounts encourages customers to remain loyal, thereby decreasing chum.

### RELATED APPLICATION INFORMATION

This application claims the benefit of U.S. Provisional Application Ser. No. 60/679,801, filed on May 11, 2005.

### FIELD OF THE INVENTION

The invention relates to systems and methods for implementing mobile loyalty programs for decreasing customer chum and increasing customer spend.

### BACKGROUND INFORMATION

As more customers adopt pre-paid services and mobile phone number portability becomes more commonplace, customer loyalty will become an even bigger problem for mobile carriers and mobile content providers as customer chum is poised to show a significant increase in the coming years.

Ultimately, carriers and content providers want to develop and cultivate their customer relationships to decrease customer chum, decrease the cost of acquiring new customers, and increase customer spend.

Accordingly, there is a need for systems and methods for implementing mobile loyalty programs that achieve these goals.

### SUMMARY

The present invention provides a Mobile Loyalty and Community Service (MLCS) that decreases customer churn and increases customer spend.

In an embodiment, the MLCS offers a suite of mobile games that customers can download onto their mobile handsets or phones. When a customer plays one of the mobile games, the MLCS issues points to the customer based on the customer's performance on the game (e.g., level reached within a game, game score, etc.), and stores the points in a customer account. Customers can redeem these points for valuable prizes from a prize catalog. The prizes may include mobile products (e.g., free games, free ringtones, etc.) as well as physical goods. The catalog can be accessed directly through the customers' mobile handsets or via the Web. The chance to win prizes based on game performance encourages customers to play the games more and to spend more on the games, thereby increasing customer spend. Further, the accumulation of points in their accounts encourages the customers to remain loyal to the carrier or content provider, thereby decreasing customer chum.

In an embodiment, the MLCS provides tokens that customers can purchase, store in their accounts, and redeem to play pay-per-play games (e.g., one token per play). The play-per-play games provide revenue for the carrier or content provider every time a customer plays a game by requiring one or more tokens for each game play. By issuing points to customers based on their performances on the games, the MLCS motivates customers to play these games more frequently, thereby increasing customer spend. Further, the pay-per-play nature of the games encourages customers to try out new games at a lower cost than outright purchase of the games.

In an embodiment, the MLCS provides a tournament service for community play with prizes attached. In this embodiment, the MLCS allows carriers or others to setup gaming tournaments for a particular game. During the tournament, the MLCS receives customers' scores for the game, and posts the top scores on a leader board (e.g., on a Web site or in the game on the mobile handset). When the tournament is finished, the customers with the top scores receive points that they can redeem for valuable prizes from the prize catalog. The tournament motivates customers to play the game for the chance to win prizes and gain recognition among their peers, thereby increasing customer spend. In addition, the community play of the tournament provides a compelling gaming experience for the participating customers. The MLCS may invite customers to the tournament by sending (Short Message Service) SMS messages to their mobile handsets. In an embodiment, the MLCS updates the leader board in real time as new scores are received. In an embodiment, the MLCS sends messages to customers informing them of the time left to participate in the tournament and/or their current rank in the tournament to encourage them to play the game more, and increase customer spend.

In an embodiment, events are communicated between peers in the MLCS network based on a publish/subscribe model, in which publishers can publish events to a topic and subscribers to the topic receive the published event via an event router. For example, a game application on a customer's handset can communicate an in-game event (e.g., level reached within the game, game score, etc.) to an MLCS server by having the game application publish the event to a specific topic on the event router and the MLCS server subscribe to that topic. This enables the MLCS to learn the performance of a customer on a game, and to issue points to the customer accordingly. Similarly multiple handset users may have expressed an interest in and subscribed to a specific topic. When the MLCS has information relevant to that topic it publishes the event to the topic and each of the subscribed handset application receives the information. Also, during a tournament, the game applications on the handsets of the participating customers' can send the game scores to the MLCS server by having the game applications publish the game scores to a topic specific to the tournament and the MLCS server subscribe to that topic. The publish/subscribe model is used to communicate events between peers on the MLCS network, including between a customer's mobile handset and an MLCS server.

Other systems, methods, features and advantages of the invention will be or will become apparent to one with skill in the art upon examination of the following figures and detailed description.

### BRIEF DESCRIPTION OF THE FIGURES

FIG. 1 shows an overview of a Mobile Loyalty and Community Service (MLCS) platform according to an embodiment of the invention.

FIG. 2 shows four technology layers of the MLCS according to an embodiment of the invention.

FIG. 3 shows a real-time messaging system for implementing a tournament according to an embodiment of the invention.

FIG. 4 shows 4+1 architecture views from a rational unified process.

FIG. 5 is a block diagram showing components of the MLCS according to an embodiment of the invention.

FIGS. 6 and 7 are flowcharts of a game billing system according to an embodiment of the invention.

### DETAILED DESCRIPTION

1 Introduction to the Mobile Loyalty and Community Service (MLCS)

The Mobile Loyalty and Community Service (MLCS) is a combination point management system and prize catalog management platform that enables application level events for issuing, redeeming and sharing tokens of any type. These tokens may include loyalty points, gaming tokens (for pay-per-play games, subscriptions, tournaments), gaming characters, or coupons that can be redeemed for prizes.

Point Management System—MLCS provides an event driven platform for storing points, currencies, tokens, coupons, etc. based upon definable user activities (e.g., voice spend, text message spend, game purchases, in game events such as a high score, etc). The system manages user loyalty accounts on behalf of the carrier. Rewards are generated for user spend by integrating with carrier reporting systems to do batch based point rewards for reported purchases. Market studies show that this can have a dramatic impact on customer spend (ARPU) for core services (e.g. voice). MLCS integrates with mobile applications like games to issue, redeem or trade these points via application definable events such as high scores, reaching a new level in a game or reaching a certain level on a tournament leader board, etc.

Prize Catalog Management—The system works with carriers to create a customized loyalty marketing solution. MLCS includes a customizable Web or WAP based redemption and prizing catalog system including support for digital and physical goods. Products can range from simple mobile content giveaways like ringtones and games to free voice minutes, text messages and handset upgrades or non-mobile products such as gift certificates, trip giveaways, concert/sporting tickets and special sweepstakes.

As will be discussed more finally below, the MLCS provides:
1. Increased Customer Spend—Loyalty points can be issued based upon spend from various services including: voice, SMS, ringtones, games, etc. Studies show that this can have a dramatic impact on customer spend.
2. In Game Loyalty Events—Loyalty points can be issued and redeemed via MLCS enabled games for a high score, reaching a new level, etc. This can serve to increase spending on games and to lower churn.
3. User Tracking and Up Selling—track and up-sell against your customer's mobile buying habits. Add simple registration capabilities to any application and use P/SMS to up-sell. Partner marketing makes unique and special offers available to your customers. Customers also receive rewards for making offers available to friends.
4. Game Tournaments for Community Play—for setting up and managing gaming tournaments with fin prizes. Skill with prize games enable 1-1 and machine play for compelling prizes.

The MLCS platform serves the carrier by increasing customer spend and decreasing churn. The MLCS provides the following benefits to a carrier:

Increase Customer Spend
Customer spend is increased by issuing points, loyalty points, to customers for making purchasing and allowing the customer to redeem the points for prizes in a catalog or entry into sweepstakes.
   1. Compelling Rewards Catalog—create national rewards programs with local market implementations. Rewards can be a combination of core mobile products (free voice, handset upgrades, free games, free ringtones) as well as compelling hard-goods. Studies have also shown that an effective local implementation in large metropolitan areas is key to success. For example, sporting tickets for local events, concert tickets, etc. in different markets such as LA, NY, Chicago, San Francisco, Seattle, Dallas, etc. can have a major impact on customer loyalty.
   2. Special Sweepstakes—Customers can exchange loyalty points for an entry in a monthly sweepstakes. Sweepstakes prizes can include cruises or other special vacation packages, special sporting events (World Series, SuperBowl, etc). If a customer has to use a fixed number of points to enter a sweepstakes drawing then that customer is motivated to increase their spend to reach the required number of points.

Decrease Customer Churn
Customer churn is decreased by creating sticky accounts and rewarding customers for forwarding promotional information to their friends.
   1. Sticky Accounts—The loyalty account is associated with the carrier and customer phone number. If the customer switches to another carrier all of the assets stored in that account (loyalty points, game tokens, coupons for prizes, etc) are deleted. This creates stickiness. Over time the system will launch more services for taking advantage of the loyalty account such as: a digital locker for managing mobile media—ringtones, graphics, photos, etc; media sharing service for sharing content across digital lockers;
   2. Sell Your Friends—The loyalty account is a great way to motivate consumers to get their friends into your network. For example, with MLCS you can automatically send a P/SMS message to any previous game buyer to buy a new game. The buyer can receive points and other rewards for sending this message to their friends who then also have the option to buy the same content and get more information about switching to your service.
      2 Examples of Applications of the MLCS

This section provides examples of applications of the MLCS. More detailed implementations of these examples are given later.

MLCS Powered Games

1 Points for Purchase (from within a Game)

User buys a game from a carrier. The game issues an event to the MLCS upon launch to credit the user with points, e.g., 25 points, as a reward for the game purchase (points are only rewarded once per purchase). It is assumed that the carrier is not involved in the point transaction. User receives a text message from the MLCS for the point award.

2 Points for Reaching a Level within a Game

After the user finished a game, the game issues an event to the MLCS announcing the game's score. If the score qualifies for points based on the game's score, then the user is awarded points and receives a text message for point award.

3 Points for Reaching the Top 100 Players for the Week

Every service enabled game has a top 100 players of the week list, which shows the scores of the top 100 players for the current week. The list is updated in real-time as new scores come in and old scores are pushed off the list. On Monday at 3 AM EST, the Top 100 players for the previous week receives awards points (according to a specific formula) along with a congratulatory text message. Other numbers of top players (e.g., Top 10) and time periods (e.g., a day) may be used.

4 Multi-Player Card Game Via Web

The MLCS allows multi-player card games, e.g., hearts, poker, spades, etc. All player moves are transmitted via a standard event model to the MLCS which then publishes the events back to the players (i.e., subscribers). These games can also be integrated with the SWP or Tournament use cases as defined below.

5 Time Duration Tournaments with Leader Board and Prizes

Any game described in this document can be turned into a tournament. Every tournament has its own leader board accessible from the web and the mobile game itself. The leader board lists the top scores received from users and is updated in real time as new scores come in. No new scores are accepted on the leader board when the tournament finishes. Every game play results in a score being published to the tournament.

The tournament host can set-up new tournaments and define point prizes via a web based interface.

Comments
1. Events and transactions should be spoof proof (only qualified/registered game/app may issue these events or execute transactions).
2. The first time a user is awarded points (i.e., their account is created), the user is asked to go to a Web or WAP site to complete their registration. This is needed to get a “handle” from the user to post the user's scores to leader board.
   MLCS Powered Skill with Prize (SWP) Games

1 Buy Tokens

If the user tries to play a game and has no tokens, then the game asks him how many tokens he wants to buy and how he wants to pay (e.g., phone bill, credit card or using existing loyalty points—default is phone bill).
1. Phone bill—equivalent psms msg is generated to cover cost of tokens.
2. Credit card or Paypal payment.
3. Existing points—equivalent number of points are deducted from the user's account (or user is informed he does not have enough points).

Once the transaction is executed game play can begin and the appropriate number of tokens is deducted form the user's account.

2 Play Mobile SWP Game and Award Points as Prizes

Assuming that the game costs one token. User starts to play a new game:
1. Deduct one token from user's account.
2. When game ends, the game issue an event to server showing user's results.
3. Credit a number of loyalty points to the user's account depending upon how well the user played the game by analyzing the event.
4. If there is no server connection at the time the game ends, then the game should keep trying to publish the event for up to one week. After one week, the game should give up but the token is still forfeit.

3 Play Web Based SWP Game

All mobile games can be ported to Flash or HTML with no loss of functionality.

Comments
1. The first time a user is awarded points (i.e., their account is created), the user is asked to go to a Web or WAP site to complete their registration. This is needed to get a “handle” from the user to post the user's scores to leader board.
2. Once a game starts, the token is forfeited and will not be refinded under any circumstances.
   MLCS Powered Mobile Content Web Portal

1 Content Management System (CMS)

Loading new content into a CMS can be done via a simple web interface bulk upload process that identifies binary/handset pairs.

2 Web Site Store Front and Shopping Cart

Back-end functionality includes the ability to create store-fronts using content in the CMS.

Front-end functionality includes the ability to sort content by country/carrier/handset and to select check-out payment type via the shopping cart.

3 Billing and Delivery

Billing is supported via PSMS (Carrier Billing), Credit Card, and Loyalty Point programs, the latter being required to build the MLCS's own redemption catalog model.

A WAP PUSH based model is used although SMS/WAP GET is a viable alternative if WAP PUSH is unavailable.

Redeem Loyalty Points Via Web Catalog

The loyalty web catalog utilizes the content web portal described above with extensions for non-mobile content products (e.g., hard goods, broadband digital media, etc.).

1 Browser Based Redemption

Browser based redemption supports all products in the catalog (e.g., mobile content broadband content, hard goods, etc.).

From the Web catalog the user can:

1. View points and account status (including transaction history—points in/out).

2. Purchase gaming tokens (for pay per play and skill with prize games).

3. Update account information if appropriate.

4. Redeem points for products/prizes.

5. Opt-in for marketing specials and mailing lists.

2 WAP Based Redemption

From the WAP browser the user can:

1. View points and account status (including transaction history—points in/out).

2. Purchase gaming tokens (for pay per play and skill with prize games).

3. Update account information if appropriate.

4. Redeem points for products/prizes.

5. Opt-in for marketing specials and mailing lists.

3 Prize Requirements

The following types of Prizes may be available in the catalog:

1. Mobile Content.

2. Other Digital Content.

3. Gift Certificates.

4. Hard Goods.

5. Sweepstakes.

4 Opt-in Marketing Requirements

Customers should have the option to OPT-IN to receive various promotional information, either through E-mail or SMS. The customer may be given incentives to sign in for OPT-IN marketing by offering sign up rewards such as tokens or reward points in their MLCS account.

MLCS Powered MVNO/Carrier Loyalty & Community Applications

1. Issue points for voice usage or other desirable activity (referring a friend, subscription to higher bucket plan, etc.) in the network.
2. Provisioning & Billing.
3. Server hooks for creating new accounts.
4. Server hooks for awarding points for voice, data and game purchases.
5. Customer support interface (view point status & transaction history points in/out, address redemption issues).
6. From Use Handset
   View point status.
   Update account information if appropriate.
   View content catalog for redemptions.
   Transfer points to friends.
   Buy Points.
      3 System Architecture
      3.1 Overiview
      The MLCS consists of four components each deriving from various feature sets:

1. Event Notification & Messaging.

2. Asset Management & Transaction Processing.

3. Web and WAP Catalogs.

4. Content Management & Delivery.

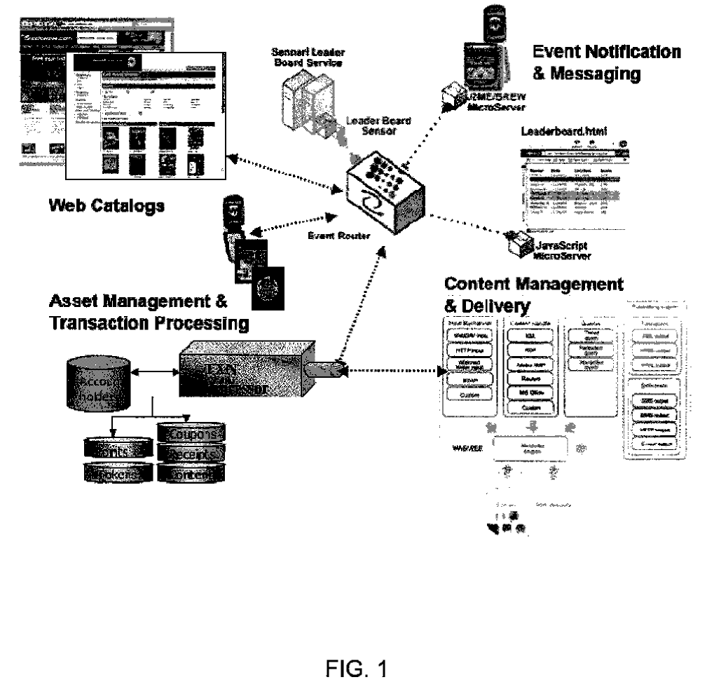

As shown in FIG. 1, these four components are tied together through a uniform event passing paradigm that is implemented by the Event Router. The Event Router mechanism implements the “message bus” of the MLCS and allows new components to be plugged into the system easily. It also facilitates many-to-many communication.

The features that make up these four components are presented in order below. The MLCS service stores all forms of tokens such as loyalty points, gaming tokens, gaming characters, digital coupons, etc in the form of digital tokens (see Technology section below for more detail). These tokens are stored in user Loyalty Accounts. The MLCS service facilitates all transaction processing such as redeeming points for prizes, issuing points, etc. Points can be redeemed via a redemption catalog or inside mobile applications (e.g. games) that support such redemptions.

The service provides three integration points into the MLCS for the carrier: 1.) Issue points for spend, 2.) Game level events for issuing/redeeming points, and 3.) Redemption Catalog (Web & WAP). Each area is reviewed in more detail below:
1. Issue point for spend—The MLCS can be integrated directly at the billing level of the carrier to facilitate the issuance of loyalty points for all purchases including voice, text, ringtones, games and other purchases. Integration is typically done via batch based reporting processes on a regular time interval (such as once per day or once per week). This is similar to the process used by affinity credit card issuers (such as airlines) for issuing miles in exchange for spend.
2. Game level events for issuing/redeeming points—The lightweight J2ME and BREW APIs provide MLCS functionality directly from the mobile application/game. The APIs offload processing, such as issue/redeem points, post a high score, receive an alert, etc., to the server, which makes the APIs very small. Strict security policies ensure that points are only being issues/redeemed in accordance with carrier policies.
3. Redemption Catalog (Web & WAP)—The service provides a set of web based functions for accessing accounts via Web or wml (WAP) pages for redeeming points for prizes, sharing content with friends (viral marketing), viewing tournament leader boards, etc.
   3.2 Definitions

1. Event

An event is information that is moved between two or more peers in a network. An event can contain notifications/alerts or signal a transaction to be executed. Generally notifications/alerts are not considered transactional when they do not involve any type of token exchange or movement of tokens. For example reporting a high score is a notification event but paying for a pay per play game is a transactional event.

Transaction events involve the exchange or redemption of tokens (see Token below) whereas notifications/alerts simply involve the movement of alerts from the publisher to the subscribers. In the case of transactions, the buyer is the publisher and the seller (or redeemer) is the subscriber. This model allows MLCS to work with many transaction and token management systems that are treated as black boxes to the MLCS by creating an orthogonal view into all token management systems that are hooked into the MLCS.

2. Peer

A peer is the generalization of all-end points in a network. When there is no server and no client everyone in the network is a peer. Peers can communicate directly (p2p) or via an intermediary (publish/subscribe). MLCS utilizes a publish/subscribe model, as several peers may need to know about data residing at a publishing peer at the same time.

3. Premium Short Message Service (PSMS)

PSMS is the application of SMS for mobile commerce. Via PSMS consumers can execute transactions from their mobile phone/handset that get billed via their phone bill. Typically such transactions happen either in the form of “short codes” which are messages that the buyer sends via his phone, for example the message “89134” sent to phone number 8768934 could mean buy a specific ringtone, send it to my phone, and bill me $1.49 via my phone bill.

4. Publish/Subscribe

Enables the movement of data between peers in a network without the need for polling or other high-overhead database style client/server implementations. A publisher makes data available to a “data bus”. The data bus is like a long water house that constantly has lots and lots of molecules moving through it. Subscribers are basically waterspouts that tap into the hose at various end-points and are only allowed to extract those molecules of data that they are allowed to subscribe to. In actuality, the MLCS Publish/Subscribe model does not require the subscriber to view all of the data molecules in the hose as the hose simply knows which molecules the subscriber expects to see and delivers only those molecules to the right water spout (subscriber). This concept is referred to as data routing or application inter-networking.

Publish/Subscribe is generally more efficient for the multi-cast of data to multiple peers than p2p style communications that has a higher overhead when communicating to multiple peers at the same time.

5. Skill with Prize (SWP) Games

A special form of game that involves prizes of monetary value based upon the successful execution of some task requiring skill on behalf of the player. TV Game shows are typical examples of SWP games.

6. SMS

Short-Text Messaging Service whereby short text messages (approximately 120 to 150 characters) can be sent to or sent from a mobile handset.

7. Token (or Asset)

A token is any form of digital asset that has some inherent monetary value to the owner of the token.

3.3 Layered System Design

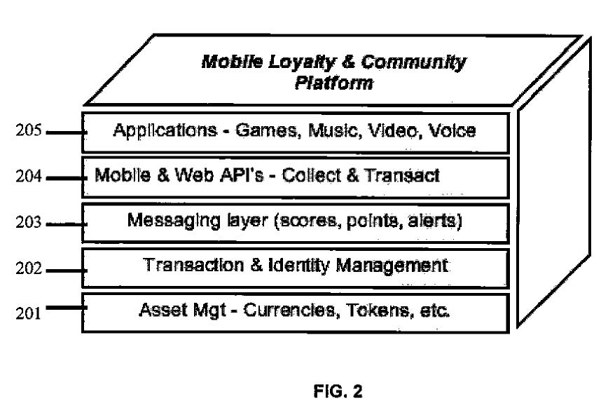

There are four primary technology layers comprising all of the Mobile Loyalty and Community Services. Together these 4 layers comprise every “Service enabled” application. Referring to FIG. 2, these layers are:

1. Asset Management Layer (Loyalty Points, Game Tokens, Game Characters) 201

2. Transaction & Identity Management Layer 202

3. Messaging Layer (Leader-board, instant messages, system alerts, etc) 203

4. Mobile & Web APIs 204

Also shown in FIG. 2 is the Application layer 205. The 4 layers of the MLCS are described in greater detail below.

Asset Management Layer

The Asset Management Layer enables the creation of, management of and transactions involving digital assets (points, tokens, characters, etc.) from within mobile and Web applications.

Different alternative implementations are possible for the Asset Management Layer. In one embodiment, all assets are stored in the system as “smart contracts.” Smart contracts are a form of digital token with special properties. These properties include: asset definition (e.g., loyalty points), business rules (transferability, copy-ability, etc.), expiration, issuer, redemption value, etc. In addition, every contract has a unique ID associated with it that makes movement of the asset throughout the system secure, fast and efficient. Smart contracts are stored as digitally signed XML documents in individual user accounts (see Identity Management below).

As all assets in the system (points, gaming tokens, gaming characters, etc.) are stored as smart contracts, every transaction (described below) is simply an exchange of contracts. This canonical view of all items of value as a single form of a contract makes it very easy for the service to create new currencies and other forms of tokens such as pay per play tokens.

In another embodiment, assets and their properties are modeled using traditional relational database techniques. Tables are defines that capture the known asset types in the system and their properties (e.g., the reward currency for a given operator, the name of the reward currency for the given operator, convertibility rules for converting such reward currency into rewards or tokens). The relational data model captures the data and their properties. The business roles to govern the integrity and processing of the data are kept as database integrity rules as well as in business logic layer. Tables are also defined to capture the amount of those assets that are in a specific user account. This embodiment can be implemented using Structured Query language (SQL), which is a well known language for managing data on relational database management systems.

While the SQL embodiment is not as flexible in incorporating changes as the XML embodiment, it has the advantage of using widely available technologies where problems of robustness and high performance have already been addressed.

Transaction & Identity Management Layer

All assets are stored in individual user accounts. These accounts can be thought of as digital safety deposit boxes where all assets are stored. Every time the user needs to alter the contents of their box, such as in the case of receiving or redeeming loyalty points, the safety deposit box is opened and the assets are either added to or withdrawn from the box. If an asset is removed from the box an audit trail is maintained in the form of a withdrawal receipt that is left behind.

To execute a transaction such as the purchase of a product in exchange for loyalty points, two assets are swapped via an escrow process. This escrow process basically takes two assets, in this case, one representing loyalty points, and another representing the product being purchased, and swaps them across accounts. One account represents the user redeeming the points and one account represents the company selling the product.

Messaging, Alerts & Real-Time Events Layer

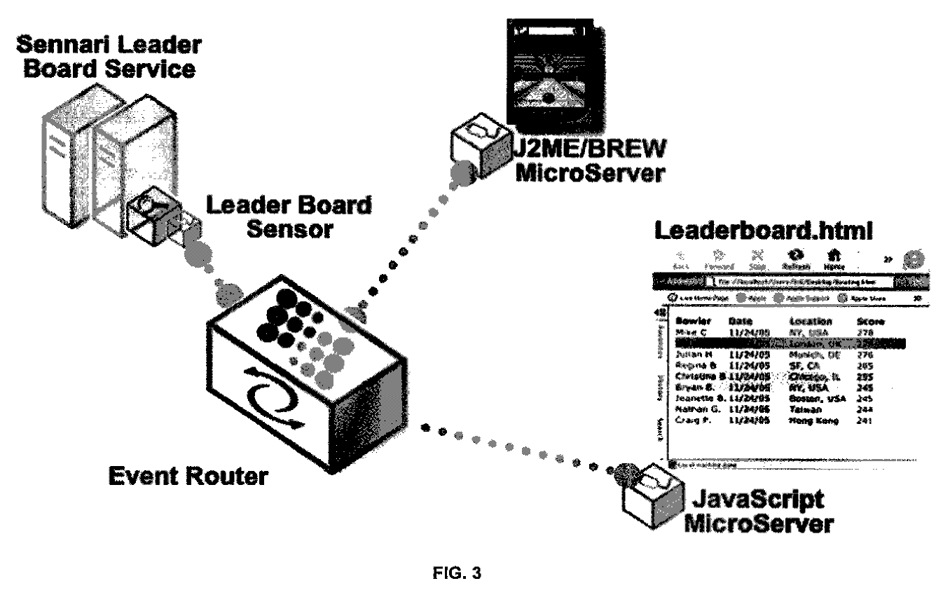

The system uses a sophisticated messaging platform to enable the publishing and subscribing of real time events (high scores, instant messages, system alerts) from within mobile and web applications. In the example shown in FIG. 3, the components shown are: Sennari Leader Board Service which tracks game leader boards, a J2ME or BREW based application where the game application is deployed and where the user acquires the score and where the leader board is displayed on the handset, and Leaderboard.html, which is a web page where the leader board is displayed in real time. The Event Router ties all these components together and provides the publish and subscribe service. The use case scenario is that the game scores are published in a tournament from a handset to a real-time event router. The event router maintains a list of all subscribers to these events and forwards the event to the Leaderboard.html web pages that are open as well as to the lead board service that the system uses to track and manage all ongoing gaming tournaments. The web page Leaderboard.html gets the event in real time and using JavaScript determines the position of the new posted score and updates its display accordingly. The Publish/Subscribe model that the system employs makes it easy to distribute events across an array of connected interfaces.

Mobile & Web APIs Layer

J2ME/BREW APIs

The API layer is the connection between the service's back end services and the mobile application. All digital assets accessed via the mobile application are accessed via the APIs. The APIs control user authentication, real-time messaging/events, token based transactions, and loyalty point issuance and redemption. As the vast majority of the processing involved is server based the APIs use very little memory.

The service provides a simple registration process for the application publisher to define new events, point schemes, tokens, etc. that are utilized from within any application. The issuer of the points must approve all loyalty point events set up for any given application/game.

Web Services

The service makes integration with traditional mobile services offered by Wireless Operators or MVNOs for loyalty points (voice, SMS, data purchases) very simple. The service offers a set of SOAP/XML based APIs that can take data from any standard reporting system (SQL, XLS, XML/fiat files, Business Objects) and generate the appropriate updates to all loyalty accounts. This completely eliminates the need to interface directly with the telecom billing system. This integration can be done rather quickly once the appropriate reporting system is in place.

Web & WAP Based Prizing and Reward Catalog

The service offers a generous web based catalog of mobile media content (ringtones, games, graphics, etc) that can be offered as loyalty premiums. This catalog can be completely re-branded and extended via third party products, sweepstakes, and other co-marketing arrangements. A direct marketing arm will work with the a catalog web master to continually update the catalog as appropriate.

Users authenticate themselves to the redemption catalog via their cell-phone number and a pin number (e.g., 4-digit pin), which is sent back to their cell-phone via SMS for security authentication.

The service also offers a WAP based version of the redemption catalog available via mobile handsets.

3.4 Auto Registration of Application

The MLCS platform and the Connector technology make it easy for applications to register with the MLCS platform without the user intervention and manual steps. This registration process is handled seamlessly in the following manner. Auto registration is complicated by issues of identification (what is the user ID to be used for the user account), authentication (how the MLCS knows that the user is who they claim to be), and repeat sign on (how does the user identify themselves every time they sign on).

Identification & Authentication

If the handset allows the application to determine the mobile number through an API, then that number is used (e.g. BREW provides an API whereby the application can determine the mobile number). However, in other situations (e.g. J2ME applications) the handset application cannot determine the mobile number.

In both these situations, one of two forms of authentication may be used. In one, the handset application sends both an HTTP request to the MLCS platform but also sends an SMS to the MLCS platform. Both these requests originating from an application contain a unique UID. MLCS matches the two requests and from the SMS request authenticates that the phone number provided on HTTP is correct.

The second form of authentication is when the handset uses WAP connectivity mode. In such mode, the operator WAP Gateway has an authentication system and forwards the MSISDN in a WAP request header. MLCS reads that and trusts such MSISDN number passed after looking at the source IP address and ensuring that it is a valid operator Gateway source IP.

Login

When MLCS identifies and authenticates an application as described above, it creates a user account on the MLCS system. The MSISDN is used as the user ID for the account. Because the login process needs to be as transparent and simple for end user, the MLCS automatically creates a secret key for the account and passes it to the handset application. On fixture logins the handset passes, in encrypted form where possible, the user ID (MSISDN) and secret key that was created at the time of registration. For applications requiring stronger authentication, e.g. cash transactions, the user could be asked to choose a password and then have to enter that on their mobile phone on each login.

3.5 MLCS Services

The MLCS platform has three core services associated with it that make it an effective solution. A user registration service allows a carrier to know who their customers are and what they are doing. A customer loyalty service establishes rewards policies for user activities of all kinds. The Tournament service enables community gaming with loyalty and prizes attached.

User Registration Service

This service turns every mobile application purchase into an ongoing customer relationship, and allows a carrier to know who is buying their games or ringtones.

The user registration service is completely user transparent and is triggered the first time any new application is run. The MLCS application extension sends the phone number along with any other relevant data to the MLCS server for processing including loyalty points for each purchase. Service details include:
1. Trivially easy to integrate via the MLCS J2ME API and BREW extension.
2. Send P/SMS messages to customers to up-sell them on new applications with instant billing.
3. The service pays for loyalty prizes for repeat purchases and sponsors ongoing. sweepstakes to encourage participant involvement.
4. Simple and affordable “per-registration” pricing model.

Customer Loyalty Service

A customer loyalty service uses the same technology as the user registration service to add flexible loyalty point capabilities to any mobile application. Applications can be made to issue or redeem points based upon application level events such as reaching a new level in a game, reaching a personal high score, etc. The system offers customized loyalty catalog and partnership marketing capabilities in accordance with publisher or carrier requirements.

Tournament Service

Gaming tournaments (poker, Tetris, hearts, spades, etc) are a great way to increase customer loyalty and spend. With this service any game can be tuned into a multi-player tournament. The system provides the web interface for setting up new tournaments, notifies participants of start and end times, manages the leader board for any running tournament, issues points to the winners, and manages the redemption of points for prizes.

The service fully integrates the loyalty & prizing system to distribute prizes to the winners and to manage ongoing participant communications via SMS, Email and the Web.

A real-time messaging system enables events and alerts (such as instant messages or new high scores) to be transmitted in real-time across phones, browsers and leader board systems.

The service uses the same J2ME API's and BREW extension as the user registration and customer loyalty services meaning that STS does not increase the overall memory footprint of the application.

Loyalty Systems Service

There is a great deal of program design that can and must be accomplished prior to the launch of any new loyalty program. The system can perform a number of program design functions that will significantly strengthen the loyalty program's presentation to prospective subscribers.

Services that can be provided in loyalty systems planning include:
1. Business case—Based on its in-depth expertise and experience in building and managing successful loyalty programs, a business case can be developed that the customer will be able to use in presenting the loyalty program concept to peers within the organization and for financial planning. The business case will describe in detail the specific value proposition, how the program will work, and the anticipated results of the program in terms of customer spend and retention. Detailed financial modeling will be undertaken.
2. Reward system—Guidance and recommendations are provided in creating a motivating and meaningful rewards structure for the proposed loyalty program concept. The optimal framework for utilizing entertainment, games and music products as well as appropriate hard goods as member rewards are developed.
At the same time, recommendations for additional rewards are developed to further enhance the member experience and drive member behavior. Sennari will use its national network of agencies and reward vendors to develop a prototype rewards offering, with the specific rewards to be determined according to the customer profile of the participating carrier.
A point-valuation framework is provided as the rewards are developed, so that this component of the program design with prospective clients (e.g., how many points do members earn for specific activities, and how many points must they redeem for specific rewards). However, the actual assignment of point values to both member behavior and to rewards will be dependent upon the value proposition of the specific Carrier/MVNO.
3. Fulfillment system—The means to fulfill all rewards including those that are furnished by the carrier are provided. As the rewards component is developed to meet the customer's loyalty objectives, the fulfillment system to be implemented is developed and specified to include each reward in the program.

Loyalty Program Design and Implementation

Once the loyalty program has been agreed to conceptually, a series of activities are coordinated that will allow us, in partnership with the carrier, to take the program from concept to execution. This phase of the project includes the following areas of program development:
1. Financial modeling and forecasting is provided—A very detailed financial plan and program forecast. These will incorporate the incremental sales impact of the loyalty program, the reduction in customer churn, and the resulting forecasted ROI based on program return vs. costs.
In addition, a comprehensive plan is prepared for point liability management, with recommendations on ways to successfully manage point liability without jeopardizing the customer impact of the program.
2. Data flow and analysis—Ongoing program results reporting and analysis are provided. A complete suite of online reports can be made available, providing real time measures of member activity and participation, reward redemption and fulfillment, and a number of other program performance measures. Additionally, Optionally a database analytics and database mining service is provided, and can generate periodic ROI analyses, to evaluate program performance
3. Communications—Member communications are a vital component of every successful customer loyalty program. As the detailed program plan is developed, the customer develops a comprehensive communications plan.
The core of the program delivery system is the base program website. It may be developed and maintained by the service to include all necessary elements of program delivery. Incentives will be created for members to visit the site frequently to: check their points history, view rewards, provide information, and participate in activities such as point auctions, surveys, instant win games, and other involving activities.
In addition, a series of member communications may be developed, in conjunction with the carrier, to spur member involvement and participation in the program. As the program evolves, and our database analyses pinpoint specific areas of opportunity, these communications will become more segmented according to member behavior as well.
4. Project Planning—A comprehensive set of project planning milestones are developed to insure the timely delivery of the loyalty program launch and implementation. All key activities, as well as responsibilities, will be incorporated into the plan and agreed to by all of the program participants. The final program costs will also be developed at that time and agreed to between the parties.
   4 Detailed Design of MLCS System

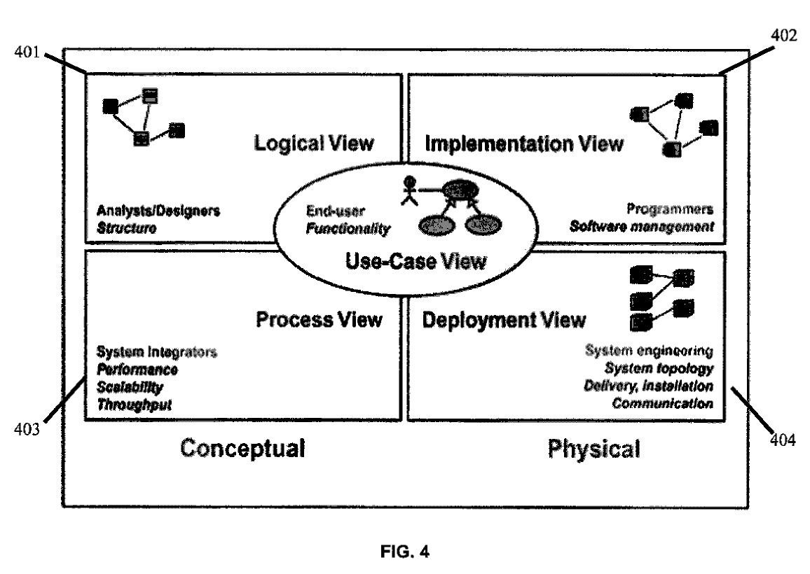

The Rational Unified Process (RUP) identifies a standard set of views called the 4+1 Architecture Views, which is depicted in FIG. 4.

Together, these views provide the development team with the necessary perspective to adequately model and build a complex enterprise system. The +1 refers to the Use Case View, which contains the key use cases that drive the architecture. The other four views are:
The Logical View 401 that describes the software structure and is used to identify major design packages, capsules, and classes.
The Implementation View 402 that provides the software's static organization in terms of packaging, layering, and configuration management.
The Process View 403 that addresses the concurrent aspect of the system at runtime: tasks, threads, or processes, and their interactions.
The Deployment View 404 that shows how the various executables and other runtime components are mapped onto the underlying platforms or computing nodes.

This document presents the architecture using a “3+1” view model. The process view included in the more traditional “4+1” view model has been subsumed by the deployment view. Wherever applicable, UML diagrams and constructs are used to represent the architecture.

4.1 Feature Requirements

This section described features of the MLCS network. The format for each feature: Code, Name, Dependencies, Description

M1—Event Definition Model

Dependencies—None

Description

The event definition model enables new forms of events (scores, messages, alerts, etc) to be transmitted to any peer in the MLCS network. An event consists of:

User, Authentication, Topic, Event Expiration Date and a Payload.

A payload can be content or a reference or an object. The return code to the publisher is a message receipt id or error message.

A uniquely published event is defined as the combination of a topic, signifying the event type, and the message receipt ID signifying that the event was successfully published.

Only certain peers are authenticated to publish or subscribe to certain topics (or event types). For example, only the MLCS server may subscribe to transaction events, Certain event types are pre-defined including:
1. Transaction—triggers the movement of assets from one peer to another (such as the issuance/redemption of loyalty points or the purchase of a ringtone).
2. Score Tournament—posts the result of a game to all subscribers (including the leader board service).
3. Score SWP—posts the result of a skill with prize game to the SWP server to determine whether any points need to be awarded to the game player.
4. Instant Message—transmits a message between peers (adds IM, alerts or system notification capabilities to any mobile application).

### EXAMPLE 1

In the case of a Tetris game where user 6502830367 (user's mobile number) gets a score of 10,730 an event might look like:
i. User: Barhydt
ii. Authentication: Password
iii. Topic: http://mlcs.sennari.com/score/sennari/tetris/6502830367
iv. Payload: 10730
v. Expiration: Jan. 1, 1970 (means never expires)
   In this example the MLCS leader board will be a subscriber to all topics starting with /score/sennari/tetris/* and will therefore receive the new score in real-time.

### EXAMPLE 2

In the case of a skill with prize game (called TriviaOne that costs 3 tokens to play), an event might look like:
i. User: Barhydt
ii. Authentication: Password
iii. Topic: http://mlcs.sennari.com/transact/sennari/TriviaOnePlay/6502830367
iv. Payload: 1 (refers to quantity being purchased)
v. Expiration: Jan. 1, 1970 (means never expires)
   In this example a transaction engine will be a subscriber to all topics starting with /transact/sennari/TriviaOnePlay/*. After publishing the transaction to this topic, the game will then subscribe to another topic called TriviaOnePlayConfirm/6502830367 which will receive a confirm or denied event once the transaction has been processed, which should only take about a second under normal conditions. If the event is a confirmation then play can begin, otherwise the game will interpret the denied code for further processing.

Developers will be able to define their own event types. For example, potential event types could include:
1. Game Play—triggers a move made by a player, perhaps in a multi-player card game such as poker or hearts or spades.
2. Vote—triggers a vote via a mobile handset application during a TV show (such as in American Idol).

The three key advantages of the event model are:

1. Moves the majority of data processing functionality off of the handset

2. Easy to program.

3. Abstracts key functions to make them easily replaceable (like the transaction engine).

M2—Event Publish/Subscribe Model

Dependencies—M1

Description

The event publish/subscribe model enables the movement of events between peers in the MLCS network without the need for polling or other high-overhead database style client/server implementations. An internet style data routing form of publish/subscribe (as opposed to a “Tibco-like” multicast model which is inefficient for Internet based applications) is utilized. The publish/subscribe API's are extremely simple and represent a way that any MLCS application can communicate with other peers. That means that the public MLCS API's can be learned in a few minutes. They are:

1. publish (user, password, topic, payload, expiration)

2. subscribe (user, password, topic, payload, expiration)

Security within the event pub/sub model is important:

1. Only authorized publishers may create new events

2. Only authorized subscribers may subscribe to published events

3. Data must not be “readable” via third parties that are “sniffing the net”

4. Data must not be “spoof-able” via third parties that wish to illegally publish events

M3—Token definition model

Dependencies—None

Description

As discussed above, at least two different embodiments of assets are possible. One embodiment utilizes the emerging industry standard definition of “smart contracts” or “smart vouchers” as the basis for token based ownership and transactions. As defined by Fujimora and Szabo, tokens (or smart vouchers) are a digital representation of the right to claim goods or services. To clarify the difference between tokens and electronic money/digital certificates, a formal definition of tokens is introduced (as abstracted and modified from the IETF documentation on the subject):

Let I be a token issuer, H be a token holder, and P be the issuer's promise to the token holder. A token is defined as the 3-tuple of <I, P, H>.

Examples of P are as follows:
1. Two loyalty points are added to the card per purchase. If you collect 50 points, you'll get one item free (Loyalty points).
2. Take 10% off your total purchase by presenting this card (Membership card).
3. Take 50% off your total purchase with this coupon. The purchase transaction uses up the coupon (Coupon).
4. The bearer can access “http:// . . . ” for one month free (Free ticket for sales promotion).
5. The bearer can exchange this ticket for the ordered clothes (Exchange ticket or Delivery note).
6. Seat number A-24 has been reserved for “a-concert” on April 2 (Event ticket).
   Note that P does not need to be described in terms of a natural language as long as the contents of the tokens are specified. For example, a set of attribute name and value pairs described in XML can be employed to define the contents.

In another embodiment, tokens are defined using relational database and data modeling techniques. The database captures the properties of the asset and the quantity of the asset in the user account. The semantic properties of the asset (e.g., 50 points get one free item) are captures using the business logic layer.

M4—Token Ownership (Identity Management) Model

Dependencies—M3

Description

Token ownership simply references the current holder of tokens as issued by MLCS. In addition to holders and issuers, the IETF model also specifies examiners and transactors. An examiner basically is responsible for redemption (as in the case of loyalty points). A transaction guarantees the legal trade of two (or more) tokens.

M5—Token transaction model

Dependencies—M3, M4

Description

There are three types of transaction possible in the standard IETF model implemented by MLCS:
1. Issue—An issue transaction is the action that creates the token referenced in the Token Definition Model and adds it to the MLCS Token Store with the issuer's intention. At issue time the Holder is the service.
2. Transfer—A transfer transaction is the action that rewrites the holder (see Token Definition Model) to be the recipient of the transfer.
3. Redemption—There are two redemption transactions: presentation and consumption.
   a. A presentation transaction is the action that shows the intention of the holder of the token although ownership is retained when the token is redeemed, e.g., redemption (presentation) of licenses or passports.
   b. A consumption transaction is the action that deletes the token to reflect the holder intention and properties of the token. The ownership of the token may be voided or the number of times it is valid reduced when the token is redeemed, e.g., redemption of event tickets or telephone cards.

Examples:
1. Spending loyalty points via a redemption catalog is a consumption transaction, which simply takes the points out of circulation.
2. Playing a pay-per-play game that costs 3 tokens to play is a two transaction process. First a transfer transaction is done to the “payee” (probably Sennari in this example). Then the tokens are redeemed for cash (where payouts are done to all revenue share partners) and taken out of circulation via a consumption transaction.
3. Playing a subscription application is executed via a presentation transaction whereby the MLCS verifies that the player has the token required to verify their subscription to the game.

M6—Tournament Model

Dependencies—M1, M2, M3, M4, M5

Description

A tournament is defined as the collection of scores from a specific game over a specific period of time. The results from this collection can be utilized to distribute prizes to participants via the MLCS.

In addition to the event and transaction models described above, a Tournament Service web site exists. The tournament service serves two purposes:
1. Business—allows game providers to set up new tournaments and award prizes for winners.
2. Consumers—allows gamers to register and see the latest leader board and results for all tournaments.
   No separate database system is required for storage of data in the Tournament model as the Event model stores all of the required information to reconstruct leader boards, determine winners, determine all future schedule tournaments, etc.

M7—Loyalty Point Model

Dependencies M1, M2, M3, M4, M5

Description

The loyalty points model pre-defines a special form of token, namely Reward Points, that can be utilized as a currency in any transaction that is deemed worthy. These transactions utilize the standard token model and token transaction models defined above.

Reward points have the following characteristics:

1) Non-transferable

2) 18 month expiration (tbc)

3) No cash redemption value

Reward points can be used as the basis for other white label reward points programs for MVNO and Carriers.

M8—Redemption Catalog Model

Dependencies—M1, M2, M3, M4, M5, M7, M11

Description

A redemption catalog is a standard “go-to” place for consumers to redeem their Reward points. The redemption catalog is implemented using the content retail model described below with extensions to support hard goods and other non-digital products such as gift certificates.

M9—Skill with Prize (SWP) Model

Dependencies—M1, M2, M3, M4, M5, M7, M8, M11

Description—

The SWP model pre-defines a special form of token (see Token Model), namely Sennari Tokens, that are utilized as payment chips for pay per play games. In addition, a special event type (see Event Model) is created, namely “Score SWP” for publishing scores back to the SWP server after a SWP game has concluded to determine whether or not a player qualifies for a prize (usually loyalty points).

Tokens can be purchased via the SWP game or any web site utilizing the content retail model described below.

M10 —Content Management Model

Dependencies—None

Description

The content management model allows the ability to store, package and deliver content for sale to any supported handset or carrier.

The system supports:

1. Content upload

2. Handset/Carrier mapping

3. Over the air delivery via WAP Push

4. Reporting

M11 —Content Retail Model

Dependencies—M10

Description—M1, M2, M3, M4, M5

The content retail model utilizes the event and token models to support the purchase of various types of tokens within MLCS. These tokens can be redeemed as: Sennari Token for pay per play (Transfer and Consumption transactions, purchase receipts to download content or ship a product (Consumption transaction), subscription tokens to access an application or portal (Presentation transaction).

Storefronts are built by defining products and purchase prices (utilizing any supported currency/payment type). The shopping cart requires the buyer to authenticate themselves to their token account (wallet) for payment processing. Store fronts and wallets are accessible from the web or the mobile handset.

Purchases can happen via:

1. Carrier based billing (PSMS)

2. Credit card

3. Loyalty Points

4. PayPal

4.2 Technology

MLCS is an architecture that leverages the Java programming language and the APIs and services of the J2EE & J2ME platform. Java, J2ME and J2EE are mature technologies that have gained wide acceptance in both the development community and in the market.

In order to be able to provide solutions to customers with a range of performance and cost constraints, MLCS may require strict adherence to J2EE standards to leverage the portability of JVMs and application servers across several OS platforms.

Further, in order to be portable on variety of mobile handsets, MLCS J2ME integration components, may require strict adherence to J2ME standards.

The MLCS architecture employs the following technologies:

J2EE
Java Server Pages
Java Servlet API
JavaBeans components
JSP taglibs
SAAJ API—for accessing web services

J2ME
MIDP 1.0
CLDC 1.0
SMS API

Architectural Patterns

The MLCS architecture employs a number of architectural patterns:
Layers—Layered architectures are very common in web-based distributed systems (and practically required in J2EE). Layered architectures promote reuse of layers, limit dependencies within the layer and enable pluggable implementations at each layer. MLCS defines several architectural layers:
Presentation Layer
Connector Layer (Integration Layer)
Event Router Layer
Business Services Layer
Data Access Layer

Component Description

Connector

Connector manages the communication between the MLCS & service enabled J2ME applications. Sennari Connector is divided in following 2 subsystems.

MLCS APIs
MLCS APIs are interfaces provided to the mobile application developer, for developing an application which uses MLCS Platform. These APIs are generic APIs for different kinds of events which can be sent to MLCS Platform.

API are described below:

MLCS_RegisterApp(AppId)
Registers the application on the MLCS platform, for the specific mobile number. AppId is the application identifier. This is a string value for e.g game name—tetris. This method should be called at the start of the game. It first checks mobile rms store to get information on whether user is registered on MLCS Platform for this application or not.
If not, then it publishes event for registration.

MLCS_AddUserInfo (Name, Address, Zipcode, Optional Info)—
Adds additional information of the user to System.

MLCS_AddCurrency (AppId, Currency Type, Amount)

Adds currency to user's account. Currency type could be any value from the following:
DL—Dollars
BL—Blings
TK—Tokens

MLCS_WithdrawCurrency(AppId, Currency Type, Amount)
Withdraws currency from the user's account.

MLCS_SendMessage (AppId, Message Type, Message)
Publishes a message to MLCS Server. Message type could be any value from the following:
   IM—Instant Message.
   AL—Alert Message.
   NT—Notification Message

MLCS_ReceiveMessage (AppId, Message Type, Message Handler)
Subscribes to MLCS Server for receiving all message, of specific type, for specified application. Message handler is callback routine, which would be called every time a message is received.

MLCS_PublishEvent(AppId, Event Type, Payload)
Publishes event from the application. For a gaming application, event type could be “Score”. For a stock market application, event type could be “Stock quotes”. Payload is a string. Publisher and Subscriber needs to follow a protocol about interpretation of Payload. Using this method, any sennari enabled application can define its own custom events.

MLCS_SubscribeEvent(AppId, Event Type, Event handler)
Subscribes to MLCS Server for receiving all events, of specified type, for specified application. Event handler is the callback routine, which would take appropriate action, everyt time a events is received.

Generic Publish/Subscribe

This is the component, which handles the communication with the MLCS. Other than basic functionality of Publish/Subscribe, it also implements other features.
Connector exposes following interface
boolean publish(String topic, SEEvent seEvent, SEStatusHandler aStatusHandler)
Publish an event to a topic. If auto-queue is on and if publish fails, then the event is written to an in-memory queue.
   topic a non-null topic name to publish an event to
   seEvent a non-null event to publish.
   aStatusHandler A status handler for any associated status events sent back by the router or null.
   return boolean—true on success, false on failure.
public SERoute subscribe(String topic, SEEventListener alistener, HashMap userdata) throws SEException
   topic as Java String, respesenting the topic to subscribe to.
   aListener as SEEventListener to handle events from the subscribed topic.
   userdata name/value pairs of optional user data or null.

Event Router
This is the component, which routes the events from one peer to another in the system. This router uses HTTP get & post for posting events and sending events.

Topic Space
In the Event Router, a uniquely published event is defined as the combination of topic, signifying the event type, and the message receipt ID signifying that the event was successfully published.

Certain event types are pre-defined including:
1. Transaction—trigger the movement of assets from one peer to another (such as the issuance/redemption of loyalty points or the purchase of a ringtone).

2. Score Tournament—posts the result of a game to all subscribers (including the leader board service).
3. Score SWP—posts the result of a skill with prize game to the SWP server to determine if any points need to be awarded to the game player.
4. Instant Message—transmits a message between peers (adds IM, alerts or system notification capabilities to any mobile application).
Since MLCS Platform would be used as ASP Service (Application Service Provider), for designing an event type system, where MLCS Platform and other subscribers can subscribe to a topic get all the events of their interest, following approach could be followed.
http://mlcs.xxx.com/<Event Type>/<CompanyName>/<AppId>/<MobileNumber>
For Event Type, short codes can be used. Some of the predefined events are listed below
Score—score: This is the event type for publishing score of a game to MLCS Platform.
SWPScore—swp: This is the event type for publishing score of a SWP game to MLCS Platform.
Transact/Token/Credit—tx/tk/cr: This is the event type for crediting token
Transac/Token/Debit—tx/tk/dr: This is the event type for debiting token
Transact/Bling/Credit—tx/bl/cr: This is the event type for crediting Blings
Transact/Bling/Debit—tx/bl/dr: This is the event type for debiting Blings
Transact/Cash/Credit—tx/csh/cr: This is the event type for crediting Cash
Transact/Cash/Debit—tx/csh/dr: This is the event type for debitingCash
Message—im This is the event type for publishing a message.
So for publishing scores of game Tetris developed by the Sennari Games, from the mobile number 9827349386 topic would be as follows:

http://mlcs.xxx.com/sc/Sennari/Tetris/9827349386
for publishing an event of debiting a token from the mobile number 982660063, for a game application “Bingo” developed by Impetus, topic would be as follows:

http://mlcs.xxx.com/tx/tk/dr/Impetus/Bingo/9826600063
Other than topics based on event types, following topics will be maintained in the system to support other functionalities.
http://mlcs.xxx.com/register—Events from the user registration service are published to this topic. This event includes the mobile number of user, sent to server through SMS by application. The mobile application subscribes to this topic and gets the event.

MLCS Server
This is the component that provides the MLCS Services. All the business rules are implemented here. It has following subsystems:

User Registration Service
This service is responsible for handling user registration. User registration request comes via SMS. It reads the SMS, checks whether user is already a MLCS registered user or not, and according registers it.

Loyalty Service
This service is responsible for managing user accounts. It handles all the assets of the users.
It uses the Transaction service for managing transactions.
LeaderBoard Service

This service is specific to gaming domain. Responsibility of this service is to maintain the scores of game. Publishing high scores of game to all peers, deciding top 100 of the week and sending notification to winners etc.

Tournament Service
This service is specific to gaming domain. This service is responsible for handling all task related to Tournament Management.

Transaction Service
This service is responsible for talking to the Asset and Transaction Services. It manages all the transactions. It creates the XML-SOAP requests to be passed to the Asset and Transaction Web Services and gets response from it and pass it to other services.

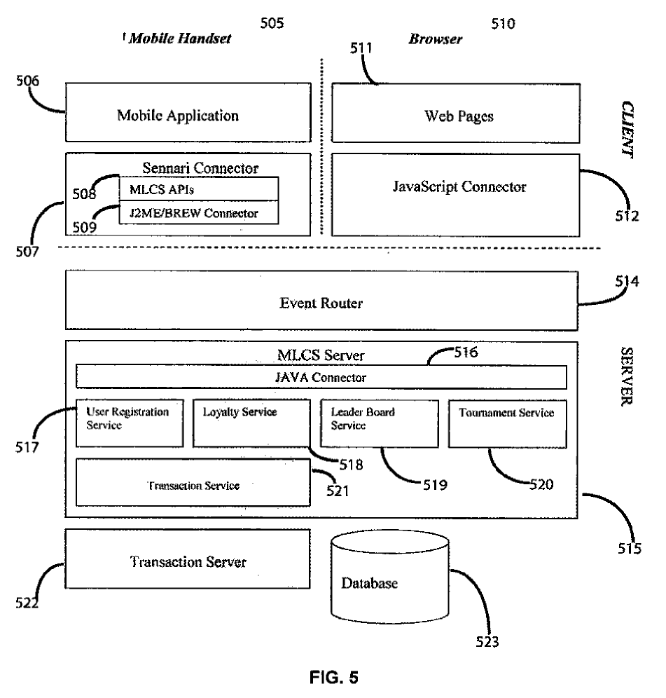

FIG. 5 is a block diagram illustrating the components described above. The mobile handset 505 on the client side includes the mobile application 506 and the connector 507 that manages communication between the mobile handset and the MLCS server 515. The connector 507 includes the MLCS APIs 508 and J2ME/BREW connector 509 described above. The client browser 510 enables the user to interact with the MLCS via the Web. The client browser 510 includes Web Pages 511 and the JavaScript connector 512 that manages communication between the browser 510 and the MLCS server 515. The Event Router 514 routes events from one peer to another in the system as described above.

The MLCS server 515 on the server side includes a JAVA connector 516 for communicating with the mobile handset 505 and client browser 512, and runs the services 517-521 for the MLCS. The services include: the User Registration Service 517, the Loyalty Service 518, the Leader Board Service 519, the Tournament Service 520, and the Transaction Service 521, as described above. The Asset & Transaction server 522 conducts the transactions for the user accounts stored in the database 523 based on requests from the Transaction Service 512 on the MLCS server 515.

Use-Case Specification and Flow

As described earlier, MLCS provides an account management system that enables all types of assets to be associated with a mobile phone number or email address. These assets can include loyalty points, gaming tokens, gaming characters used in longlived games (e.g., EverQuest), or coupons used for redeeming prizes. There are four primary services associated with the Mobile Loyalty and Community Service:
1. User Registration Service.
2. Customer Loyalty Service for issuing and redeeming points within mobile applications including loyalty points and gaming tokens.
3. Tournament Service for setting up and managing gaming tournaments fully integrated with the Loyalty & Prizing System.
4. White Label MLCS—for carriers and MVNOs who want to offer a self-branded version of all the services for customer loyalty and retention.

User Registration Service

The user registration service allows a simple, seamless and user transparent user registration process to any mobile game or application. The user registration process triggers the first time users start the applications. The carrier and publishers can use the user registration service for up-selling the buyer for services such as entertainment titles, etc.

Actors

The following actors will be involved:
1. Mobile handset user. Mobile handset owner who will use the MCLS enabled mobile applications.
2. Mobile application: MLCS enabled mobile application or game that issues/receives various events to and from the MLCS platform including user registration.
3. User Registration Server: Middleware application responsible for handling user registration requests from the mobile applications.
4. User registration service: for adding user accounts into the Asset & Transaction platform.
5. Transaction service: for crediting, maintaining and other loyalty based transaction services.
6. Carrier/publisher: The carrier or publisher can issue P/SMS messages for up-selling the buyer on future entertainment titles.
7. Event Router: The event router which routes events from one component to other.

Preconditions/Assumptions
During the startup the mobile application must be able to provide an Application identifier so that the MLCS platform can identify the game of mobile application

Flow of Events
1. User buys a game or mobile application from any carrier or store front.
2. User downloads the application to his or her mobile handset.
3. User starts the application.
4. Application looks into the persistent storage of the mobile handset (i.e., RMS) to check whether the user is already registered with the service or not based on the application identifier.
5. If the user is not registered, then the application subscribes to the topic http://mlcs.xxx.com/registration/<uid> and stores the <uid> into the persistent storage of mobile handset.
6. If the user is not already registered with the service, then the application sends a SMS to a MLCS Server using SMS API. The SMS includes the UniqueUserID (uid).
7. The ESME application on the MLCS Server will persist user mobile number & uid in a database and will create an account in the Asset & Transaction.
8. MLCS Server will also persist information that this user has registered for this specific application.
9. MLCS Server will publish the result of the account registration action on topic http://mlcs.xxx.com/registration/<uid>. Payload of the event includes the mobile number of the user as well as the result of the account creation action.
10. If account registration is successful, the application will set the registered flag in RMS as well as stores the mobile number in RMS.
11. If account registration is successful, the MLCS server will credit “award points” in the user account.
12. MLCS Server will publish an event to the topic http://mlcs.xxx.com/tetris/98273493866. The payload would be a message that “You have been rewarded 50 award points for registering”.

Alternative Flow of Events

If the user is already registered for the same application with the service, then an alternative flow takes place. It is assumed that the registration flag on handset storage is set for that application, and that the Mobile number of the user is stored on the handset persistent store.

Another alternative flow of events is possible if mobile application has sent the user registration SMS to the MLCS but does not receive a registration confirmation event from the MLCS. In this case, Registration flag on handset storage is set to ST_SMS_SENT (i.e. SMS has been sent for registration) for that application and the following flow takes place.
1. Application will retrieve <uid> stored on the handset for the application.
2. Application will subscribe to topic http://mlcs.xxx.com/registration/<uid>.
3. Application will get one of following responses.
   a. Service not available due to non availability of MLCS services.
   b. Registration confirmation response. In this case, the application will set the registered flag in RMS as well as store the mobile number in RMS.
4. If application does not get any response, this indicates MLCS Server did not receive registration SMS. In this case the application will clear the state stored and repeats the User registration use case.

Customer Loyalty Service

The customer loyalty service provides necessary interfaces and infrastructure for setting up flexible loyalty point capabilities to any mobile application and managing loyalty points.

The loyalty points model pre-defines a special form of token, namely Reward Points that can be utilized as a currency in any transaction. Reward Points have the following characteristics:

a.) Non-transferable.

b.) 18 month expiration (tbc).

c.) No cash redemption value.

A platform is provided that stores points and other assets/tokens in secure accounts. Applications can be made to issue or redeem points based upon application level events such as reaching a new level in a game, reaching a personal high score, etc.

A customized loyalty catalog and partnership marketing capabilities are offered in accordance with publisher or carrier requirements.

Actors

The following actors will be involved:
1. Mobile handset user: Mobile handset owner who will use the MCLS enabled mobile applications.
2. Mobile application: MLCS enabled mobile application or game that issues/receives various events to and from the MLCS platform including user registration.
3. Loyalty Service: Middleware application responsible for managing all loyalty points activities.
4. Transaction Service: Responsible for invoking transaction services of Asset and Transaction Component and maintaining transaction log.
5. Leader Board WEB/WAP Page: Page showing scores of a game.
6. Asset and transaction service: for crediting, maintaining and other loyalty based transaction services.
7. Event Router: The event router which routes events from one component to other.

Points for Reaching a New Level in a MLCS Enabled Single Player Game:

This use case describes the behavior, when a user reaches a new level in a game. The use case is triggered when a user reaches a new level in a game.

Actors

Mobile Handset User

Mobile Application

Loyalty Service

Transaction Service

Leader Board WEB/WAP Page

Asset & Transaction Service

Event Router

Pre-Conditions/Assumptions
1. User is a registered user, which indicates that User has an Account in the Asset and Transaction Service.
2. Information such as Mobile number, Application Identifier is stored on the mobile handset.
3. The LeaderBoard service on the MLCS Server has subscribed to the topic http://mlcs.xxx.com/Sennari/Level.
4. The Loyalty service on the MLCS Server has subscribed to the topic http://mlcs.xxx.com/Sennari/Level.
5. Mappings of Level & points issued are stored in a XML file. (All business rule would be stored in XML files).

Basic Flow of Events
1. User starts the application
2. If the user is playing the game for the first time, then the User Registration Use Case will be executed. Application looks into the persistent storage of mobile handset (i.e. RMS) to check whether user is already registered with the service or not based on the application identifier.
3. If the User reaches a new level in the game, the game application publishes an event to the topic http://mlcs.xxx.com/xxx/Level/<GAME>/<MobileNumber>on Event Router.
   The event might look like
   i. User: <MobileNumber>6502830367
   ii. Topic: http://mlcs.xxx.com//sennari/Level/Tetris/6502830367
   iii. Payload: 3 (refers to the level the user has reached)
   iv. Expiration: Jan. 1, 1970 (means never expires)
4. The Loyalty Service on the MLCS Server receives the event, as it has a subscription to this topic, from Event Router. The service fetches information about the Points to be awarded from the XML mapping file.
5. The Loyalty service publishes an event of type “Issue Transiction” for Transaction Service. Upon receiving the event the Transaction Service executes the Asset and transaction service to create a Token of, e.g., 50 Points.
6. If the above transaction is successful, then the Loyalty service publishes an event of type “Transfer Transaction”. Transaction Service executes transaction service to update the account of user “6502830367” by the issued award Points. Basically it transfers the above create Token to the user.
7. The Loyalty service publishes an event to the topic http://mlcs.xxx.com/xxx/IM/<MobileNumber> on the Event Router.
   The event might look like
   i. Topic: http://mlcs.xxx.com//xxx/IM/6502830367
   ii. Payload; “Congratulations, You have awarded 50 points for reaching the level 3 in Tetris Game”
   iii. Expiration: Jan. 1, 1970 (means never expires)
8. The mobile application receives the instant message.

Points for Reaching a Score in a MLCS Enabled Single Player Game:

This use case describes the behavior when a game is finished. The use case is triggered at the end of the game.

Actors

Mobile Handset User

Mobile Application

Loyalty Service

Transaction Service

Leader Board WEB/WAP Page

Asset & Transaction Service

Event Router

Pre-Conditions/Assumptions
1. User is a registered user, which indicates that User has an Account with Asset and Transaction Service.
2. Information such as Mobile number, Application Identifier are stored on the mobile handset.
3. The LeaderBoard service on the MLCS Server has subscribed to the topic http://mlcs.xxx.com/xxx/Score.
4. The Loyalty service on the MLCS Server has subscribed to the topic http://mlcs.xxx.com/xxx/Score.
5. Mappings of Score & points issued are stored in a XML file. (All business rule would be stored in XML files).

Basic Flow of Events
1. User finishes the game application.
2. The game application publishes an event to the topic http://mlcs.xxx.com/xxx/Score/<GAME>/<MobileNumber> on Event Router.
   The event might look like
   i. User: 6502830367
   ii. Topic: http://mlcs.xxx.com//sennari/Scorel/Tetris/6502830367
   iii. Payload: 10000 (refers to score user has made)
   iv. Expiration: Jan. 1, 1970 (means never expires)
3. The Loyalty Service on the MLCS Server receives the event as it has a subscription to this topic, on Event Router. The service fetches information about the Points Issued from the XML mapping file.
4. The Loyalty service publishes an event of type “Issue Transaction” for Transaction Service. On receiving the event the Transaction Service executes the transaction service to create a Token of, e.g., 50 Points,
5. If the above transaction is successful, Loyalty service publishes an event of type “Transfer Transaction”. Transaction Service executes transaction service to update the account of user “6502830367” by issued Points. Basically it transfers the above created Token to user.
6. The Loyalty service publishes an event to the topic http://mlcs.xxx.com/xxx/IM/<MobileNumber>.
   The event might look like
   i. Topic: http://mlcs.xxx.com//xxx/IM/6502830367
   ii. Payload: “Congratulations, You have awarded 50 Points for scoring 10000 points in the Tetris Game”
   iii. Expiration: Jan. 1, 1970 (means never expires)
7. The mobile application receives the instant message.

Points for Reaching Top 100 Players for the Week:

Every service enabled game has a top 100 of the week list, which shows the top 100 scores for the current week. The list is updated in real-time as new scores come in and old scores are pushed off the list. This use case is triggered, e.g., on Monday at 3 AM EST.

Actors

Mobile Application

Loyalty Service

Transaction Service

Leader Board Service

Leader Board WEB/WAP Page

Asset & Transaction Service

Event Router

Pre-Conditions/Assumptions
The formula for awarding points to top 100 of week is stored in a XML file. (All business rule would be stored in XML files)

Basic Flow of Events
1. On Monday at 3 AM EST, Leader Board Service calculates the Top 100 scores for the previous week.
2. The LeaderBoard Service, issues a request to Loyalty Service for awarding Points to the users with the Top 100 scores of week. In turn, Loyalty Service issues a request to Transaction Service.
3. Transaction Service calls the Asset and transaction service to update the accounts of all Top 100 of week users.
4. The Loyalty service publishes an event to the topic http://mlcs.xxx.com/xxx/IM/<MobileNumber> on Event Router for each player in the Top 100 of week list.
   The event might look like
   i. Topic: http://mles.xxx.com/xxx/IM/6502830367
   ii. Payload: “Congratulations, You have awarded 50 Points for being on the Top 100 of week list in the Tetris Game”
   iii. Expiration: Jan. 1, 1970 (means never expires)
5. The mobile application receives the instant message.

Play MLCS Enabled SWP Game:

The SWP model pre-defines a special form of token, namely Tokens, that are utilized as payment chips for pay per play games. In addition, a special event type is created, namely “Score SWP” for publishing scores back to the SWP server after a SWP game has concluded to determine whether or not a player qualifies for a prize (usually loyalty points), Tokens can be purchased via the SWP game or any web site utilizing the content retail model.

Actors

Mobile Application

Loyalty Service

Transaction Service

Asset & Transaction Service

Event Router

SWP Service

Pre-Conditions/Assumptions
1. The game costs one token per play.
2. Loyalty service subscribes to http://mlcs.xxx.com//xxx/SWPScore/Tetris/

Basic Flow of Events
1. User starts to play a new game.
2. The game publishes a “Transfer Transaction” Event to transfer the one Gaming Token from user's account to an account on Event Router.
3. The Transaction Service subscribes to this event and issues a request to Transaction Service for executing this transaction.
4. The service will check the user account and if there are sufficient Gaming Tokens, then deduct the one Token and responses that transaction is successful completed.
5. Now game publishes a “Consumption Transaction” event to redeem that Token.
6. The Transaction service receives the event & destroys the Gaming Token.
7. The Loyalty service publishes an event to the topic http://mlcs.xxx.com/xxx/SWP/Tetris/<MobileNumber> on the Event Router including the result of transaction in Payload.
   The event might look like:
   i. Topic: http:mlcs.xxx.com/xxx/SWP/Tetris/6502830367
   ii. Payload: <Transaction Status>
   iii. Expiration: Jan. 1, 1970 (means never expires)
8. User continues the game.
9. When the user finishes the game, game issues an event containing the score in payload to Event Router on topic http://mlcs.xxx.com//xxx/SWPScore/Tetris/6502830367
10. Loyalty service receives this event and analyzes the results as per the business rules and determines the prize to be awarded
11. Loyalty service updates the account based on prize. The prizes can be awarded in following ways:
   a. Points
   b. Gaming tokens
   c. Coupons
12. Loyalty service sends and instant back to the user informing him about the prize awarded.

Buying Gaming Token for SWP Game:

This use case describes the flow of events when user want to purchase gaming tokens from within mobile application.

Actors

Mobile Application

Loyalty Service

Asset & Transaction Service

Event Router

Pre-Conditions/Assumptions
1. Loyalty service subscribes to http://mlcs.xxx.com//xxx/transaction/Tetris/.

Basic Flow of Events
1. User starts to play a new game
2. The user does not have sufficient gaming tokens to play the game
3. User is asked to purchase the tokens by the game
4. User is provided following payment options
   a. Existing Sennari points
   b. PSMS carrier billing
5. User select the payment method
6. The game will issue and event to Loyalty service containing information about payment method.
7. Depending on payment method Loyalty service will then issues a transaction event to Transaction service
8. Transaction service after receiving the above event will execute transaction service to credit gaming tokens into the user account
9. User will be notified about the transaction status

Tournament Use Cases

Tournament service A tournament can be defined as the collection of scores from a specific game over a specific period of time. The results from this collection can be utilized to distribute prizes to participants via MLCS.

Tournament service provides necessary interfaces and infrastructure for setting up and managing tournaments. Every tournament has its own leader board accessible from web and mobile game itself. The leader boards are updated in real-time as new scores comes in. tournament hosts can set-up new tournaments and define point prizes via web based interface.

Actors

The following actors will be involved:
1. Mobile handset user: Mobile handset owner who will use the MCLS enabled mobile applications.
2. Mobile application: MLCS enabled mobile application or game that issues/receives various events to and from the MLCS platform including user registration.
3. Loyalty Service: Application can use Loyalty service to add flexible loyalty points, issue or redeem points based upon application level events etc.
4. Leader board WAB/WAP Page: The leader boards are updated in real time as new scores come in.
5. Tournament service: for managing tournaments.
6. Administrator: or game provider is responsible for tournament setup.

MLCS Tournament Setup:

MLCS Tournament setup use case allows Tournament administrator to setup and manage Tournaments.

Actors

Administrator or game providers

Tournament service

Basic Flow of Events
1. Administrator logs on the tournament setup WEB portal by using <username> and <password>.
2. Tournament service verifies the password and allows access if password is correct.
3. Administrator gets the list of available mobile games. List of available games will be fetched from local database maintained by the Tournament service. Database could be an XML file.
4. If the tournament is a new tournament, tournament administrator selects the game for setting up new tournament.
5. Administrator specifies the start and end-time of the tournament.
6. Administrator sets up prizes and loyalty points for the tournament. This includes following
   a. Initial tokens required to play the tournament.
   b. Loyalty points awarded at each level or milestone.
   c. Prizes awarded for winners.
7. Tournament service will fetch the list of participants from database and then notifies participants about the start and end timings. This could be done using following ways:
   a. SMS
   b. Email
   c. Publishing an event to the Event Router
8. Leader board page will then subscribe to http://mlcs.xxx.com/<score>/xxx/<gamename>/*.

Running Tournament:

This use case describes the flow of events while the tournament is running.

Basic Flow of Events
1. User starts the game.
2. An event is published from Tournament server notifying that the Tournament is running.
3. User continues the game and scores are published to the Event Router.
4. When the user finishes the game, based on Tournament Subscription Token user have, the user's score will be posted in the Tournament.
5. Tournament Service calculates the Top scorers (based on the business rules) and publish event for the same.
6. Leader Board receives these events and accordingly updates itself.
7 At the end of Tournament, all Top scorers are awarded prizes. Tournament Service publishes event to Transaction service to update the user accounts with the awarded prizes.
8. Tournament Service sends a congratulatory message to all the top scorers or winner. This could be done using following ways:
   a. SMS
   b. Email
   c. Publishing an event to Event Router
      Events Specification
      Front End Events:
Automatic User Registration (Mobile Phone #)
   This would be triggered by mobile application via SMS to MLCS server. MLCS server checks whether mobile number already exists or not. If not then it creates the user account and notifies the user by publishing an event containing mobile number in payload to Event Router.
User Registration, Optional Additional Information (Name, Username, Opt ins, address, zip code)
   MLCS APIs both Java & j2me) will be provided to publish additional (optional) information to the server
View Account Balance—Points, Custom Currencies, Tokens
   The mobile application will issue an event to MLCS for getting account balance information. MLCS APIs (both Java & J2ME) will be provided for this. In response to this event the MLCS server will publish an event which will contain account details i.e. Points, Custom Currencies, Tokens user have, in payload.
View Product Catalog—Mobile Applications, Ringtones, Screen Images
   The mobile application will issue an event to MLCS for getting product catalog information. MLCS APIs (both Java & J2ME) will be provided for this. In response to this event the MLCS server will publish an event which will contain product details i.e. Mobile Applications, Ringtones, Screen Images available in payload.
View Redemption Catalog—Mobile Applications, Ringtones, Screen Images, other
   For above three points we can adopt one of the following approaches:
      Publish an event to event router and get the response over subscription
      Post a query directly to MLCS servlet interface.
         This will use a separate connection in addition to the existing connection used for Event Router.
Add Cash to Account
   This event would be used to add Cash$, Tokens and Bling to the user account.
Redeem Points/Custom Currencies For Prize
Withdraw Cash/Tokens
   Need more clarification on this event, which scenario this event would be published
Purchase Tokens with Cash
Send Message To Server
Receive Message From Server
Debit Token From Account
View End User High Score
   This event would be published to get the high score of the user. For example if Bob plays Tetris game 10 times, the high score would return the highest score achieved by the Bob out of these 10 scores.
View All High Scores for Specific Game
Get New Game Assets (Questions, Levels, Maps, Characters)
Player Matching
Game Seeding
   End of Game Events:
Where leaderboards are used for a mobile game application, submit High Score (event occurs before returning to front end)
For tournaments, submit Head to Head Result (event occurs before returning to front end)
View Account Balance—amount of Points, Custom Currencies, Tokens
   Business Rules for Games:
Before the current game/match has been completed:
   If the user quits the game: points/currency/tokens spent data is automatically queued on the mobile client.
   If the user turns off the phone: the user loses all points/currency that was spent to play the game.
   If the user closes the phone: the user loses all points/currency/tokens that were spent to play the game.
   If the user looses phone power due to a dead battery or they remove the battery from the phone: the user loses all points/currency/tokens that were spent to play the game.
   If the user ends the game the user loses all points/currency/tokens that were spent to play the game. Ending game is defined as quitting the game before the natural conclusion to the game.
As soon as the game is over, the results (high score, head to head results), point awards, tokens, and currencies must be reported to the server immediately before any other actions are allowed.
   If a connection cannot be established or is lost during data transmission, the mobile client will try to send the data X times before the data message is queued,
There are no refunds, the token is debited from the account before the game is allowed to start.
When a game is interrupted by a phone call: Game is paused and can be resumed.
When a game is interrupted by a SMS: Game is paused and can be resumed.
When a game is interrupted by a Text Message: Game is paused and can be resumed.
When a game is interrupted by an email: Game is paused and can be resumed.
   Games Billing System

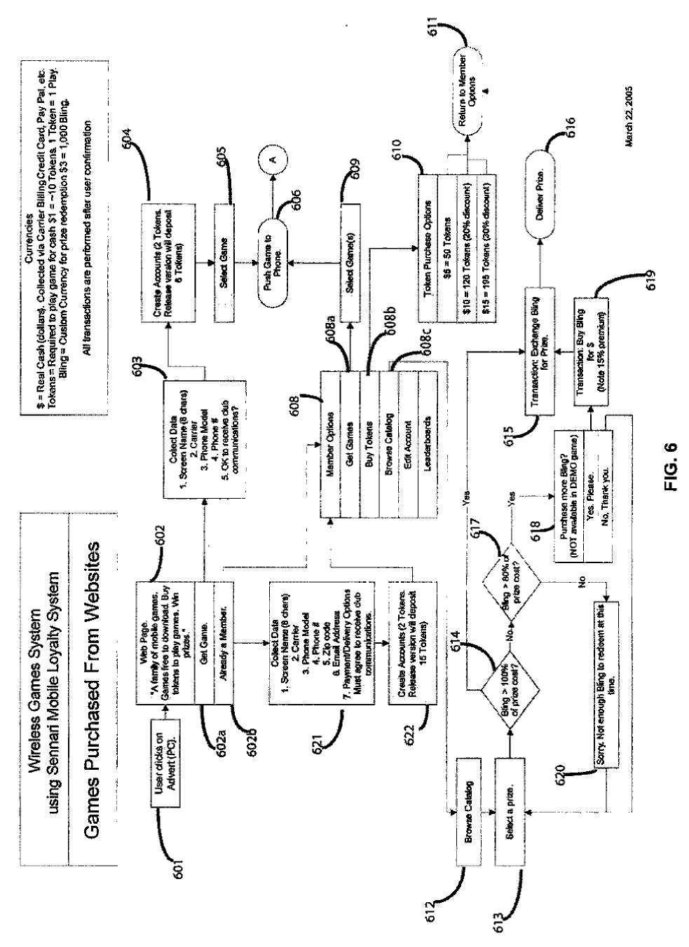

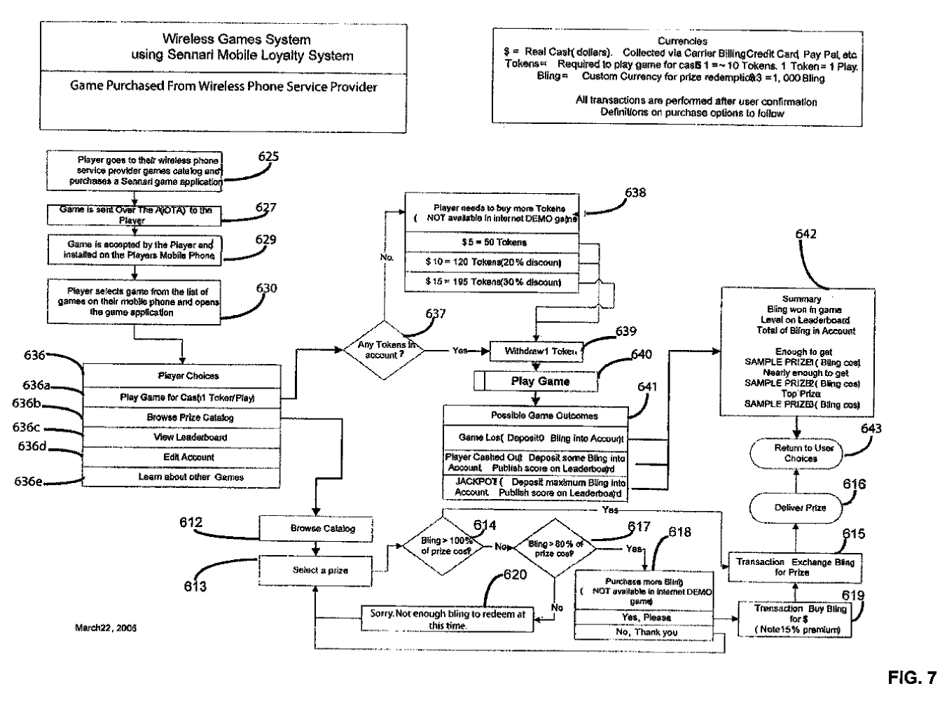

FIGS. 6 and 7 are flowcharts illustrating a Games Billing System according to an embodiment of the invention.

Turning to FIG. 6, in step 601, the user clicks onto an advertisement, e.g., on the Web. In step 602, a webpage opens on the user's PC or WAP enabled mobile phone. The webpage invites non-members to join with promotional information and presents three options to the user: get Internet demo game 602a, login as an existing member 602b, or join the service 602c.

If the user selects option 602a, then the system collects data from the user in step 603. In step 604, the system creates an account for the user and deposits two or more tokens in the user's account. In step 605, the user selects a game to try out, e.g., from a game catalog. In step 606, the selected game is pushed onto the user's mobile phone.

If the user selects option 602b, then the system lists member options for current members in step 608. The options include: getting games 608a, buying game tokens 608b, and browsing the catalog 608c. If the user selects option 608a, then the user selects a game, e.g., from a game catalog in step 609. In step 606, the selected game is pushed onto the user's mobile phone. If the user selects option 608b, then the system gives the user different options for purchasing game tokens in step 610. After the user purchases tokens, the user moves to step 611 and returns to member options in step 608. If the user selects option 608c, then the system presents a catalog for the user to browse in step 612 showing prizes for which the user can redeem “Bling” currency, where “Bling” currency is a brand name for points that can be redeemed for prizes. Other names may be used for the points. In step 613, the user selects a prize from the catalog. In step 614, the system determines whether there is enough “Bling” currency in the user's account for the selected prize. If the user has enough “Bling” currency, then the user advances to step 615 to exchange the “Bling” currency in the users account for the selected prize. In step 616, the selected prize is delivered to the user (e.g., if the prize is a ringtone, then the ringtone is pushed onto the user's mobile phone).

If the user does not have enough “Bling” currency in step 614, then the user advances to step 617, where the system determines whether the user has more then 80% of the “Bling” currency needed for the selected prize. If the user has more than 80% of the “Bling” currency needed, then the system gives the user the option of purchasing “Bling” currency to cover the difference in step 618. If the user selects to purchase “Bling” currency, then the user buys the “Bling” in step 619, and advances to step 615. If the user selects not to purchase “Bling” currency in step 618, then the system returns the user to step 613. If the user does not have more than 80% of the “Bling” currency needed for the selected prize in step 617, then the system informs the user that he does not have enough “Bling” in step 620, and returns the user to step 613. Another percentage may be used instead of 80%.

If the user selects option 602c, then the system collects data from the user in step 621 to register the user as a new member. The data may include payment information (e.g., credit card information) and delivery information (e.g., address). In step 622, the system creates an account for the user and deposits two or more tokens in the user's account. The user then advances to member options in step 608.

Turning to FIG. 7, in step 625, the user goes to a wireless service provider's game catalog and purchases a game application. In step 627, the game application is sent to the users mobile phone over the air. In step 629, the game is installed on the user's mobile phone. In step 630, the user elects a game from a list of games on his mobile phone and opens the game application. Alternatively, the game application can be sent to and installed on the user's mobile phone for free.

In step 636, the user is given different user choices including: play game for cash 636a, and browse prize catalog 636b, view leader board 636c, edit the user's account 636d, and learn about other games 636e. If the user selects to browse the prize catalog 636b, then the user goes through the same steps as shown in FIG. 6. If the user decides to play a game 636a, then the system determines whether the user has any tokens in his account in step 637. If the user has no tokens in his account, then the system gives the user different options for purchasing tokens in step 638. If the user has tokens in his account, then the system withdraws one token from the user's account in step 639. In this example, a game costs one token to play; however, other games may cost more tokens to play. In step 640, the user plays the game on his mobile phone. In step 641, the user is issued “Bling” currency based on the outcome of the game. In step 642, the user is presented with a summary including the amount of “Bling” currency won in the game, and the total amount of “Bling” currency in the user's account. The summary may also include the user's rank on a leader board, e.g., if the user is participating in a tournament or a top 100 of the week list). The summary may also include sample prizes and the amount of “Bling” they cost to encourage the user to play again. The user then moves to step 643 and returns to user choices in step 636.

Although the present invention has been described in terms of the presently preferred embodiments, it is to be understood that the disclosure is not to be interpreted as limiting. Various alterations and modifications will no doubt become apparent to those skilled in the art after having read this disclosure. Accordingly, it is intended that the appended claims be interpreted as covering all alterations and modifications as fall within the spirit and scope of the invention.

1. A method for implementing a loyalty program based on mobile games, comprising:
offering tokens for purchase to a customer, wherein the customer can redeem the tokens to play games on a mobile device of the customer;
storing tokens purchased by the customer into an account;
enabling the customer to play a game on the mobile when the customer redeems one or more of the purchased tokens to play the game; and
deducting tokens redeemed to play the game from the account.

2. The method of claim 1, further comprising:
issuing points to the customer based on a performance of the customer on the game; and
providing a catalog to the customer, wherein the customer can redeem the issued points for prizes in the catalog.

3. The method of claim 2, wherein the prizes in the catalog include digital content that can be downloaded onto the mobile device.

4. The method of claim 2, wherein the customer can access the catalog through the mobile device.

5. The method of claim 1, further comprising billing the customer for token purchases through a mobile carrier billing system.

6. The method of claim 1, wherein the customer can purchase tokens through the mobile device.

7. The method of claim 1, wherein the game is capable of reporting in-game events to a server, and further comprising:
after the customer finishes playing the game on the mobile device, having the game report an in-game event to the server;
receiving the in-game event at the server;
issuing points to the customer based on the in-game event; and
providing a catalog to the customer, wherein the customer can redeem the issued points for prizes in the catalog.

8. The method of claim 7, wherein the in-game event includes reaching a level within the game.

9. The method of claim 7, wherein the in-game event includes a game score.

10. The method of claim 7, wherein the prizes in the catalog include digital content that can be downloaded onto the mobile device.

11. The method of claim 9, further comprising:
receiving game scores from other players;
comparing the game score of the customer to the game scores of the other players; and
issuing points to the customer based on the comparison.

12. The method of claim 10, further comprising:
receiving the game scores of the customer and the other players over a period of time; and
issuing points to the customer if the game score of the customer is within a top group of the received game scores.

13. The method of claim 12, further comprising providing a leader board listing the received game scores of the customer and the other players in order of descending score from a top score.

14. The method of claim 13, wherein the leader board is accessible through the mobile device.

15. The method of claim 13, further comprising sending a message to the customer informing the customer of a rank of the customer on the leader board.

16. The method of claim 1, further comprising:
enabling the customer to play the game at least once for free; and
subsequently, requiring the customer to redeem one or more tokens to play the game.

17. The method of claim 1, wherein the mobile device is a mobile phone.

18. A method of conducting a gaming tournament, comprising:
offering tokens for purchase, wherein the tokens can be redeemed to play a game;
enabling each one of a plurality of players to play the game on a mobile device when the player redeems one or more tokens to play the game;
receiving game scores for the game from the plurality of players over a period of time;
determining players having game scores within a top group of the received game scores;
issuing points to the players within the top group; and
providing a catalog, wherein the issued points can be redeemed for prizes in the catalog.

19. The method of claim 18, further comprising providing a leader board listing received game scores in order of descending score from a top score.

20. The method of claim 19, further comprising updating the leader board in real-time each time a game score is received from one of the players.

21. The method of claim 19, further comprising sending messages to the players, wherein each message includes a rank of the respective player on the leader board.

22. The method of claim 19, further comprising sending messages to the players, wherein each message includes an update of the leader board.

23. The method of claim 19, further comprising sending messages to the players, wherein each message includes a time period left for participating in the tournament.

24. The method of claim 19, wherein the leader board is accessible through the mobile devices of the players.

25. The method of claim 18, wherein the players can purchase the tokens to play the game through their mobile devices.

26. The method of claim 18, wherein the mobile device is a mobile phone.

27. A game application stored in memory of a mobile device, the game application comprising:
instructions for sending a transaction message to a server over a wireless connection, wherein the transaction message includes a request to redeem one or more tokens in a user account to play the game application;
instructions for receiving a confirmation from the server over a wireless connection;
instructions for enabling a user to play the game application on the mobile device upon receiving the confirmation; and
instructions for sending an in-game event to the server after the user finishes playing the game application.

28. The game application of claim 27, wherein the mobile device is a mobile phone and the in-game event includes the user's mobile phone number.

29. The game application of claim 28, wherein the in-game event includes reaching a level within the game.

30. The game application of claim 28, wherein the in-game event includes a game score.

31. The game application of claim 27, wherein the instructions for sending the transaction message comprises instructions for publishing the transaction message to a topic on an event router.

32. The game application of claim 27, wherein the instructions for sending the in-game event comprises publishing the in-game event to a topic on an event router.

33. The game application of claim 27, wherein the instructions for receiving the confirmation comprises subscribing to a topic on an event router.
